(19) United States
(12) Patent Application Publication
(10) Pub. No.: US 2005/0214161 A1
(43) Pub. Date: Sep. 29, 2005

(54) Test device for simultaneous measurement of multiple analytes in a single sample

(76) Inventor: Surendra K. Gupta, Laguna Niguel, CA (US)

Correspondence Address: MARY HELEN SEARS;M.H. SEARS LAW FIRM, CHTD., Suite 800, 910 Seventeenth Street, N.W., Washington, DC, 20006, US

(21) Appl. No.: 10/806,461

(22) Filed: Mar. 23, 2004

(51) Int. Cl. G01N 31/22

(52) U.S. Cl. 422/56

(57) ABSTRACT

The invention consists of a test device for simultaneous measurement of multiple analytes in one sample where the liquid sample is applied to a matrix at the central area of the device which is connected to multiple arms, and each of the arms contains specific reagents in dry form for measurement of a particular analyte. The sample travels from the center uniformly and quickly to the reagent site on each arm and produces a measurable signal that may be a change in electrical charge or current, fluorescence, or, preferably, color. A color change can be detected visually or measured quantitatively using a suitable reflectance meter. The sample may be a small amount of whole blood obtained e.g., from a finger puncture or it may be urine, saliva, any other bodily fluid, environmental water, or any other fluid upon which rapid, simultaneous testing of levels of different components is desired. According to the invention, a disease specific panel for kidney, liver, heart, lipid disorders or for early detection of dysfunction of general health can be performed at or near the patients' site and can provide instant results. Similarly, rapid simultaneous testing of water samples is desirable under many circumstances.

### INTRODUCTION

The present invention relates to a convenient, portable device wherein rapid simultaneous measurement of concentrations of multiple analytes present in a test sample can be made. It is particularly useful in facilitating on-site diagnosis of organ-specific disorders of the heart, liver, kidney and pancreas in mammalian patients, but it also can advantageously be used for many other purposes.

### BACKGROUND OF THE INVENTION

The availability of simultaneous, rapid measurement of multiple analytes, such as chemicals, metabolites, or enzymes in a single sample with a convenient, easily portable device could provide many benefits in numerous milieus, including agricultural, industrial, environmental, hospital and other settings. In the diagnosis and management of mammalian, including human, disorders and diseases, rapid measurement of multiple analytes can provide better, more timely management of patient care because it gives instant, on-site results wherever the patient may be located, including the home, the physician's or veterinary office, an emergency room or out-patient clinic or health care center, a long term human care facility, or even a battlefield or accident scene. There is a particular need, in on-site diagnostic testing, for a device or system that provides a maximum of information from a single small sample, such as the quantum of blood collectable from puncturing a human finger or domestic animal's paw.

In the field of medical diagnosis, urine test strips containing multiple pads, each specific to detection of an analyte, have been commercially available for over three decades from Bayer and its predecessor, Miles Laboratories, and also from Boehringer Mannheim, now Roche Diagnostics. These strips provide instant, qualitative or semi-quantitative results. However, each individual test pad requires a separate application of sample, there being no arrangement available that permits sample flow simultaneously to all test pads from one location.

Recognizing the fact that, in many cases, improved diagnosis and monitoring of human or animal diseases can best be accomplished when quantitative answers establishing the levels of a plurality of analytes present in blood or other bodily fluids are available, some devices have been developed in the past. Among those known, the Seralyzer® (from Miles Laboratories), the Ektachem® from Eastman Kodak, (now available from Ortho Diagnostics) and a device available from Kyoto Daiichi Kagaku have all provided quantitative measurements of analytes but were limited in use to measurements made on serum or plasma rather than whole blood. Since obtaining serum or plasma requires centrifugation or other separation of a blood sample, which can take 10-20 minutes and normally cannot feasibly be done in a home, nursing home facility or at an accident scene or a battlefield, the need for serum or plasma is a drawback to the use of these devices in many situations. Additionally, in these systems, the strip or slide that must be used for each test requires a separate application of sample. These instruments are large in size and hence not readily portable. In addition, the test measurements cannot be carried out in simultaneous rapid fashion.

Various U.S. patents, among which U.S. Pat. Nos. 5,796,272 and 5,589,399 are exemplary, describe devices, which use serum or plasma as a sample rather than blood. Other similar devices for detection of analytes are described in U.S. Pat. Nos. 4,323,536; 5,126,276;and 5,646,503.

Further systems known in the prior art that measure various analytes in blood are I-Stat® (From I-Stat, Inc.), Reflotron® (from Boehringer Mannheim), and Stat-Site® (described in U.S. Pat. No. 5,104,619), but each of these systems requires a separate sample in order to test for each desired analyte.

U.S. Pat. No. 5,110,724 (Cholestech Corp), describes a system for simultaneously measuring various analytes constituting a lipid panel of Total cholesterol, HDL-cholesterol, and triglyceride. This system, however, is not truly portable and has a central blood filtering mechanism that is prone to clogging when a sample of high hematocrit is introduced. It also requires a large blood sample, in the order of 75 μl, which normally cannot be obtained from a simple human finger or animal paw puncture.

Most recently, Polymer Technology Systems has introduced a system for simultaneous measurement of a lipid profile, and U.S. Pat. No. 6,524,864 describes another system for simultaneous measurement of multiple analytes. Both of these utilize whole blood samples; however, both systems suffer from the following drawbacks:
(i) they each require about 40-75 μl of blood.
(ii) they are comprised of multiple layers or membranes that are stacked together under pressure. The blood sample is applied from the top. The top membrane is a ‘spreading layer’ having the function of uniformly spreading the blood and transferring it to the adjacent underlayer. This underlayer is a second membrane, the function of which is to separate red blood cells from blood and promote flow of the separated plasma to multiple spots, usually three in number but in some instances four, all located beneath this layer and isolated therefrom by intervening plastic material. Each spot consists of a separate membrane containing necessary dry ingredients which are specific for measurement of an individual analyte. The plasma reacts with the specific ingredients of each spot and produces a color which is quantitatively measured by a reflectance meter.
(iii) These devices require pressure to perform the overall test. This sometimes results in clogging the blood separation layer and inhibiting the flow of plasma, thereby causing variability in the sample volumes transferred to the various test spots.

For the aforesaid reasons, such designs are prone to analytical errors and provide results of less than the acceptable quality needed for clinical interpretation. It is the overall object of the present invention to overcome the drawbacks of prior art systems and provide a system that is more versatile and capable of use wherever it may be desirable to use it.

In particular, the present invention simultaneously measures the concentration of multiple analytes in any convenient bodily fluid, including whole blood. Its sample volume requirement is typically in the order of 10-25 μL and it does not require multiple layers or pressure application to achieve uniform distribution of the sample.

### BRIEF DESCRIPTION OF THE INVENTION

The present invention involves using a matrix constituting a membrane or other substrate configured in a shape that has a central area with multiple extended arms which connect to central area. This substrate is stably supported on a rigid to semi-rigid support structure which can be made from any of a number of common plastics.

The preferred membrane material for use with blood and other heterogeneous liquid media that contain solid or semi-solid material dispersed therein is generally of the type that has a gradient in pore size from its upper to its lower surface so that it exerts a sieving effect on, e.g. whole blood, whereby it retains red cells in its central portion at about mid level of the membrane thickness. This preferred membrane for heterogeneous test samples is also so selected that it exhibits high lateral diffusive characteristics whereby the liquid portion of any sample flows rapidly to each of the arms. Materials displaying these characteristics that are currently available are asymmetric membranes and some polyethylene sulfone membranes which, though not described as “asymmetric”, display the necessary effects. For samples appearing to be essentially homogeneous liquids, any membrane having good lateral diffusion characteristics is acceptable, including any of the several general purpose filter papers available on the market. The substrate material is for one-time-only use and is to be discarded after each test and replaced with a fresh substrate sheet.

The various reagents needed for measuring individual analyte concentrations are largely applied to the substrate matrix, preferably at the extremities of each of the outward-extending arms, so that each arm is prepared by impregnation with a set of reagents which devote it to a particular measurement of a specific analyte likely, or known, to be present in the sample. The separate reactions which occur at each of the extremities can be measured as to change in color and intensity, changes in fluorescence or by electrochemical changes, using known devices for making such measurements.

In practice, different membranes or other substrates may be employed at the ends of the arms from those utilized in the arms for merely transporting liquid thereto, and the membrane in the central portion of the device where sample is first applied may be different from that in the arms and from one or all of those present at individual test stations. When employing different substrates in this manner, commonly known bridge pads, used routinely in conveying liquids between unlike substrates, are interposed as needed to abut each of two unlike substrates and assure a smooth transition of liquid between them.

The reagents necessary for each individual test are preferably applied to each of the substrates to be employed at the extremities of the arms of the device by spraying a solution of desired reagents in a solvent on the substrate material and then drying it. Alternatively, substrate may be dipped in a solution of reagents needed for the test to which that arm is to be devoted and is then dried in an oven for an appropriate period, and applied to the appropriate arm.

The reagent combinations necessary for individual tests are those well known in the art as explained more fully hereinafter.

The same format of the test device can be used with appropriately prepared arms for testing to determine concentrations of various substances in mammalian fluids such as urine or saliva, as well as blood, for testing concentrations of various nutrients in foods, for detecting the presence of various substances in soils and water, for monitoring water in swimming pools or fish tanks or water in wells and cisterns and even water in streams, lakes, etc., for testing drugs and pharmaceuticals for various ingredients and for many other purposes that will readily occur to those skilled in the arts of analytical or diagnostic chemistry.

The device of this invention is also useful for conducting assays wherein the red cells in whole blood are lysed and their contents are analyzed for various substances. In such instances, the sample is lysed in the central position of the device and there is no need to use special membrane material having a pore size gradient from top to bottom; ordinary filter paper or membrane is adequate.

The base of the device can be made of any semirigid solid plastic or equivalent material to which the substrate can be stably affixed during the analyses of any given sample and from which the sample substrate can then be readily removed. The base may be then washed or otherwise cleaned and prepared for the next sample analysis by attaching a fresh sample substrate sheet thereto. Alternatively, the base may be constructed of at least semi-rigid disposable material and discarded after each series of tests in a given sample.

Examples of possible configurations of the device, including the disposition of the arms relative to the sample receiving member are depicted in the figures. Other equally useful embodiments will readily occur to those of ordinary skill in the art.

### BRIEF DESCRIPTION OF THE DRAWINGS

FIG. 1 shows a device with 4 arms surrounding a central polystyrene (or other plastic) sample receiving area. This device is suitable for measurement of up to four analytes simultaneously. The arms are each connected to the center. Each arm has been designed in a triangular shape so that it requires a minimum volume of sample. Each arm is clearly separated from the others.

FIG. 2 shows essentially the same device with arms that are rectangularly shaped.

FIG. 3 depicts a configuration of device wherein the sample receiving area is of rectangular shape with four arms, all extended horizontally in the same direction.

FIG. 4 shows a two-armed device similar to FIG. 1.

FIGS. 5, 6, 7 and 8 depict devices each similar to FIG. 1, but bearing 3 arms, 8 arms, 12 arms, and 16 arms, respectively.

FIG. 9 shows a device prepared for simultaneously measuring a panel of lipid analytes—namely total cholesterol, HDL-cholesterol, and triglycerides. Similar devices, shown in FIGS. 10 and 11 depict devices with sample substrate pieces prepared for simultaneously measuring a kidney panel of BUN (blood urea nitrogen), creatinine and albumin plus ammonia (FIG. 10) or phosphorous (FIG. 11).

### DETAILED DESCRIPTION OF THE INVENTION

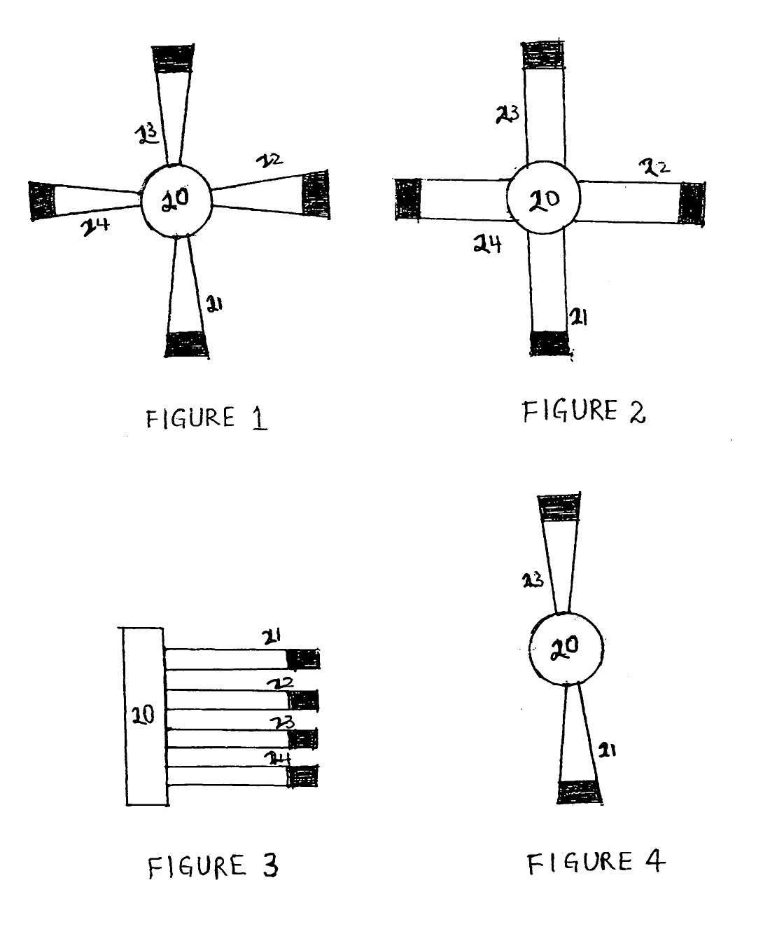

FIG. 1 illustrates a top view of the essential parts of the device of the present invention. They consist of a membrane, which maybe “die-cut” with a central area (20) and four arms (21, 22, 23, and 24). The membrane may be fixed to a semi-rigid substrate such as polystyrene or another plastic, with thickness e.g., in the order of 0.010 to 0.025 in., by any convenient means. Among such well known means is double-faced adhesive tape but many equally effective, convenient means will readily occur to those skilled in the art. The arms (21-24) are connected to the center (20) but are clearly separated from each other. The center (20) is shown in FIG. 1 as a circle but it can be in another shape, such as a square, rectangular, oval, pentagonal or any other convenient shape. The center (20) is preferably a circle of approximately 4-8 millimeters in diameter, but larger or smaller sizes can readily be used if desired. Each arm preferably has a length of about 6 to 12 mm and has a width approximately of about 2-4 millimeters at the outside and about 1-2 millimeters towards the end that connects to the center, but these dimensions can be varied substantially without departure from the scope of this invention. On each arm, preferably at the end about 1-2 μl of reagents specific for an analyte is air-brushed and dried at 37° to 60° c. for 5-10 minutes. Alternatively, the reagents may be applied by impregnation from solution.

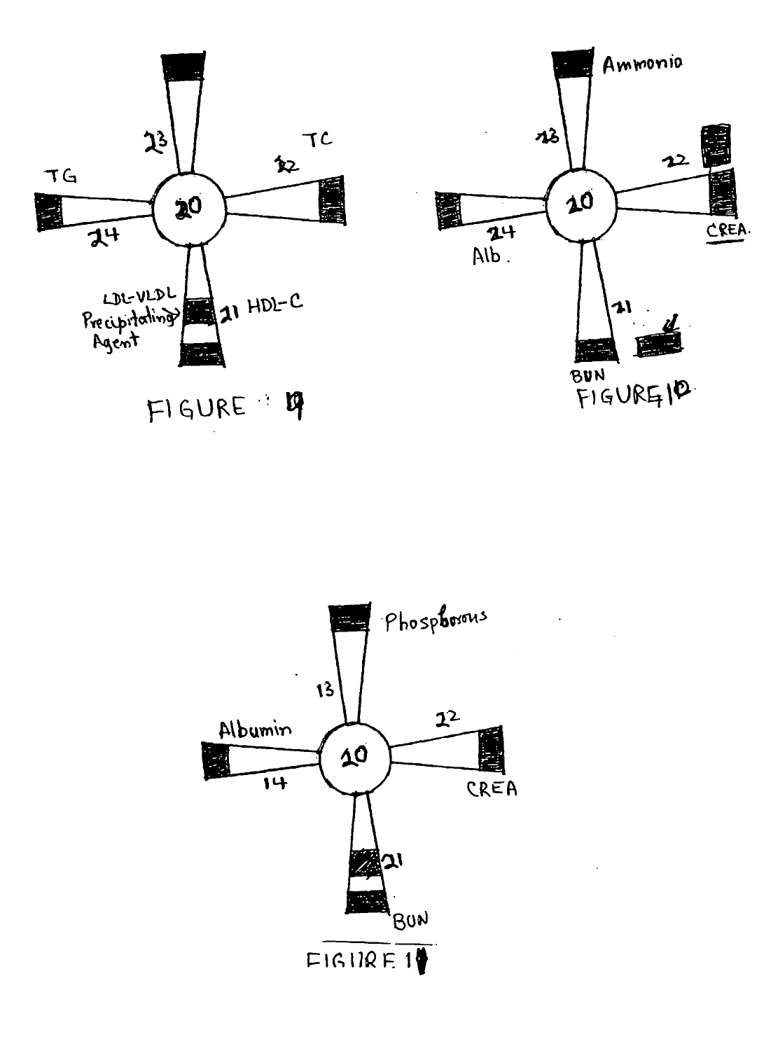

When the sample travels from the center to the end of each arm, each analyte present in the sample reacts with those reagents for its detection that are deposited on one arm and produces a measurable signal such as color, fluorescence, or an electrical signal. The intensity of the signal is proportional to the concentration of the analyte present in the sample and is measured by a reflectance meter in the case of color, by a fluorimeter for fluorescence and in the case of electrical signals by measuring current or voltage with an ammeter or voltmeter. The device of any of FIGS. 1-9 can be used for conducting a disease-specific panel of tests on a single sample. Possible panels may measure, e.g., a patient's blood lipid values, kidney output contents, blood electrolyte levels, liver enzyme concentrations, etc.

FIG. 9 shows a device to which a panel of lipid tests has been applied. In FIG. 9, arm 21 has two zones of reagent deposits, so arranged that the sample will first pass from the center into a zone layered with low density lipid-very low density lipid (“LDL-VLDL”) cholesterol precipitating agent, thus insuring that only the high density lipid (“HDL”) cholesterol in the sample will reach the zone at the end of the arm where reagents reactive with HDL have been deposited. Also in FIG. 9, arm 22 has reagents for measuring total cholesterol deposited at its farthest point from the center 20 and arm 24 has reagents for measuring total glycerides at its extremity farthest from the center. Similarly to arm 21 in FIG. 9, a device intended for measurement of blood component levels indicative of abnormal heart function will have one arm devoted to measuring creatinine kinase-MB (“CK-MB”). This arm will have two zones of reagents deposited so that the first reagent zone the sample encounters will react with and remove creatinine-kinase-MM isozyme (“CK-MM”) from the sample, while the second reagent zone at the arm's extremity farthest from the sample well will measure CK-MB concentration in the sample.

FIG. 10 shows the essential parts of the device prepared to run a kidney test panel. The test device may contain an additional substrate layer at the reagent site, either above or below the membrane. For example, 0.2μ polyethylene sulfone membrane may be double layered at such spots, or layered with a different membrane so that reagents which are not compatible can be deposited separately in each of two separate layers.

FIG. 11 shows another example of a device prepared for a typical kidney test panel. The test device may contain reagents for BUN that would react with one another if deposited in admixture and thus prevent analyte in the sample from reacting with either. By depositing reagents in appropriate order in separate zones on the arm, such problems are avoided.

FIG. 3 is intended to illustrate that the essential parts of the device may take many configurations and forms. As presented it has a sample well area 20 that is rectangular with four arms extending outwardly in the same direction. These arms could be arranged in other ways, e.g., two could extend on each side of the center in opposite directions.

The figures herein are intended to be exemplary rather than limiting. The highest number of arms depicted in the figures for example, is 16, but in practice a lesser or greater number of arms may afford more practical results, depending upon the sample size available, the nature of the sample and whether it is able to diffuse rapidly and evenly outward among all the arms of the device.

Many other possible shapes of the center sample-receiving membrane and its relation to the arms, which could be, e.g. ellipsoidal or trapezoidal as well as triangular or rectangular, as depicted, can readily be envisioned. Those presented here in the various figures are exemplary and in no sense limiting.

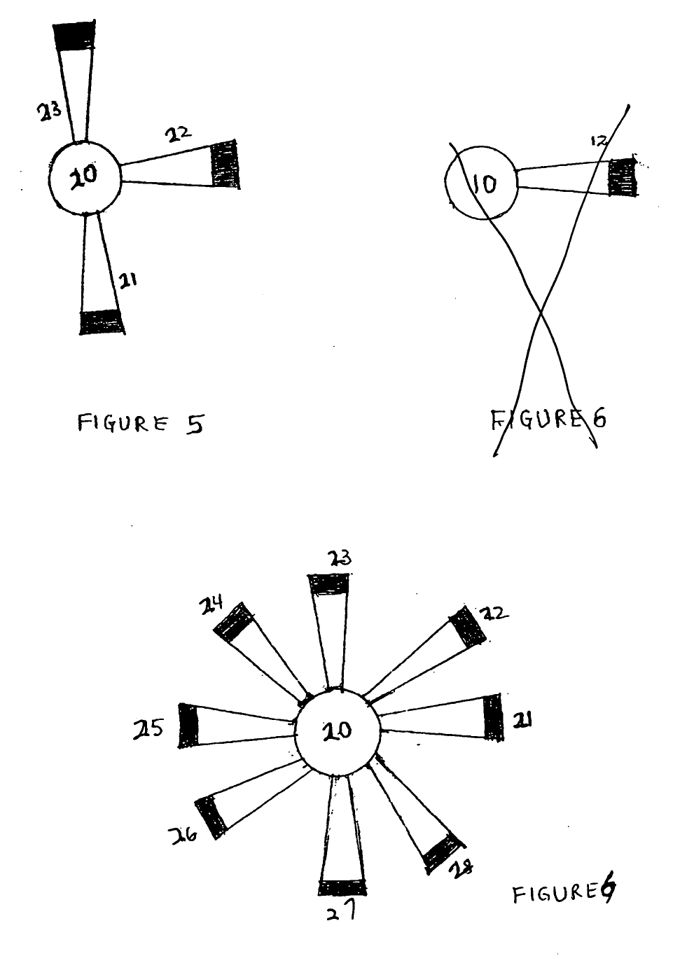

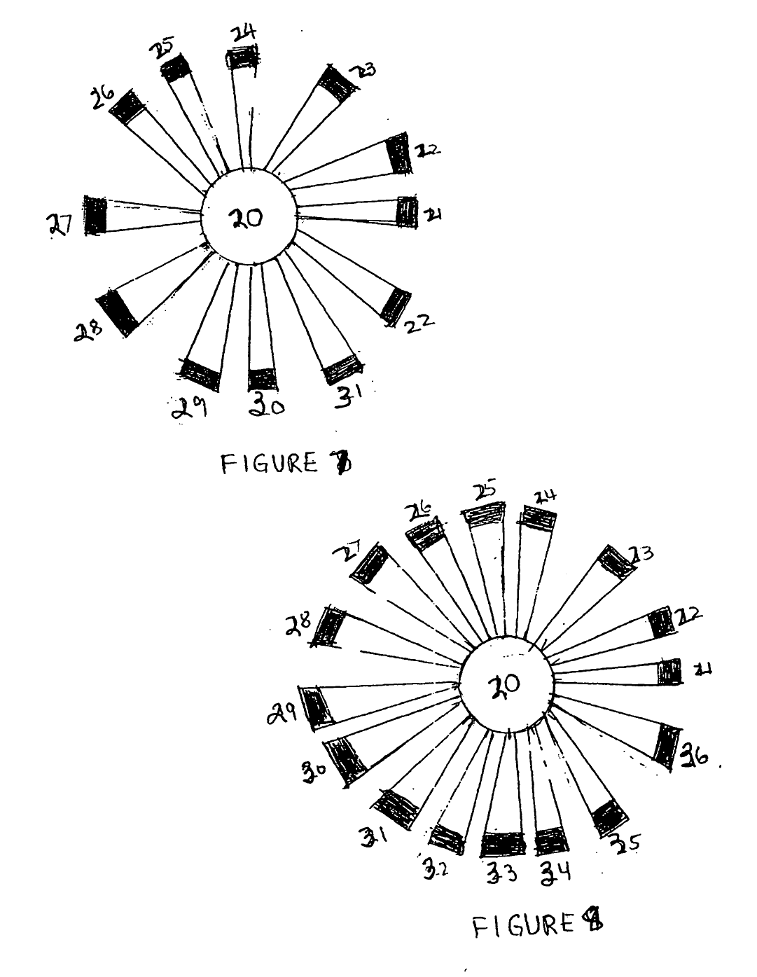

The device shown in FIG. 5 is similar to FIG. 1 except it has three arms suitable for the measurement of up to three tests simultaneously. For example, glucose, ketone and glycated hemoglobin can each be measured on one sample as a diabetes panel. Similarly, alanine aminotransferase, aspartate aminotransferase, and alkaline phosphatase can be separately measured on the same sample as a liver function panel.

For measuring general health on one sample, reagents for measuring any combination of analytes from among glucose, cholesterol, triglycerides, alanine aminotransferase, aspartate aminotransferase, alkaline aminotransferase, lactate dehydrogenase, creatinine kinase (total), creatinine kinase-MB, bilirubin, calcium, magnesium, carbon dioxide, total protein, albumin, urea, creatinine, uric acid, lipase, HDC-cholesterol, or a host of other analytes known in the art may be deposited approximately on the arms of the device and the determinations made simultaneously on a single sample of body fluid.

In neonatal patients, for example, when an innate metabolic disorder is suspected, the device of this invention may test for the phenylalanine abnormality typical of phenylketonuria, the galactose abnormality due to galactosemia or the homocysteine abnormality due to homocystinuria on a single blood sample when arms devoted to each test are appropriately disposed around a central sample receiving area.

When analytes of interest typically are present inside red blood cells which must first be lysed, the lysing is accomplished in the central sample receiving section of the device and arms devoted to analyzing for some or all of hemoglobin, glycated hemoglobin, glucose-6-phosphate dehydrogenase, pyruvate kinase, glucose phosphate isomerase, pyrimidine-5-nucleotidase or 2,3-diphosphoglycerate or other substances known to be found in red blood cells are disposed around the central area.

For on-site blood chemistry analysis, where a finger puncture using a fine needle generally results in 10-25 μl of blood, it is of considerable importance to choose membrane materials to make the essential parts of the device which (a) use a small blood volume and (b) are capable of separating or significantly retarding red blood cells instantly and allowing plasma to diffuse quickly. When the intensity of color is to be measured, the membrane should also have high reflective value. The reflective value is important in measurement of analytes because good discrimination throughout the entire clinical range must be obtained so that acceptable precision and accuracy criteria are met. It is also desirable that the area containing red blood cells be small and capable of holding these cells together in a tight spot so that they do not diffuse into and interfere with the functioning of any reagent-containing arm site.

Where the sample is plasma or serum obtained by prior separation of blood in a laboratory, or the analyte is present in the red blood cells, or the blood is pre-diluted, the choice of membrane is of less significance. Filter papers rather than membranes can be used for devices employed for testing of urine, environmental water, saliva or extracts from food or environmental samples.

Few commercially available membranes were found in the investigations leading up to this invention that met the criteria stated above for membranes that can be successfully used in the testing of whole blood. Two classes of membranes, asymmetric membranes and polyethylenesulfone (PES) membranes, were particularly useful. Millipore Corp (Bedford, Mass.), Pall Corporation Port Washington, N.Y.), Spectral (Toronto, Canada), Schleicher & Schuell (Keene, N.H.) and Ahlstrom (Mt. Hollyspring, Pa.) provide asymmetric membranes and PES membranes. Asymmetric membranes are designed so that they have a gradient in terms of pore size, i.e. smaller pore size at the top with a shiny surface and larger pore size at the bottom with a dull or matte surface, thereby offering a gradual sieving effect based on molecular size. For example, the top of the membrane may have a pore size of 0.1 to 0.5μ, and the bottom of the membrane may have a pore size of 10-20μ. Porosity gradually increases from top of the membrane to the bottom. The red blood cells are 4-7μ in size, and when a blood sample is placed either at the top or the bottom of the membrane, the membrane holds the red blood cells in the middle and plasma is diffused in the surrounding area. The material of these membranes is not clearly defined by the suppliers but some of them appear to consist of PES. Similarly some other PES membranes, such as those provided by Osmonic (Westborough, Mass.), Sartorius (Germany), and Pall Corporation, are not described by suppliers as asymmetrical but they appear to accomplish the same goals. These membranes hold most of the red blood cells and allow plasma to diffuse to the surrounding areas. Some of the suppliers and membranes found to be useful in this invention when whole blood is the sample are listed in the following Table.

TABLE

| | | Preferred configuration |
|---|---|---|
| Supplier | Type of membrane | for blood sample |
| Millipore | High Asymmetry PES | HAPES |
| | (HAPES), Low Symmetry | |
| | PES (LAPES) | |
| Pall Corp | BTS-30, BTS-50, BTS-100 | BTS-30, BTS-50 |
| | PES, presence 0.2μ, | |
| | Super 450 | |
| Spectral | C/S, C/Q, SR, S | C/S, C/Q, SR, S |
| Diagnostics | | |
| Ahlstorm | Cytosep ® 1660, 1662, 1663 | |
| Osmonics | PES, 0.2μ, 0.5μ, 0.8μ | PES-0.8μ |
| Schleicher & | Accusep ® | |
| Schuell | | |
| Sartorius | PES, 0.45μ | PES-0.45μ |

The plasma contains enzymes and proteins (molecular weight of 30,000 to 300,000) and metabolites (molecular weight of 50-1000), which are much smaller in size. The rate of diffusion depends upon the surface, the structure, and the material of the membrane and, therefore, varies from membrane to membrane.

The chemistries for measurement of specific analytes described herein are well known in the prior art. Most or all of them can be easily found in “Laboratory techniques in biochemistry and molecular biology; dry chemistry analysis with carrier-bound reagents” by O. Sonntag; Elsevier publication (1993), and in Tietz Textbook of Clinical Chemistry-Edited by C. A. Burtis and E. R. Ashwood, 3^{rd} edition, Saunders publication (1999). Other sources for analytical chemistries are also available and can easily be located in a literature search.

It is also well known that a variety of tests can be conducted to determine the status of disease that is specific to a particular organ. Similarly, a variety of tests are used as a general health panel (GHP). It is also well known that the method for measurement of analyte can be either colorimetric, photometric or electrochemical.

The methods are suitable for measurement of blood from the finger or from plasma or serum.

In FIG. 9, where simultaneous measurement of Total cholesterol, HDL-cholesterol and triglyceride are to be effected on a single sample, the typical cholesterol reagent consists of a combination of microbial cholesterol esterase; cholesterol oxidase; horseradish peroxidase; 4-aminoantipyrine, phenol or a phenol derivative such as 3,5 dimethoxy-N-(2-hydroxyl-3-sulfopropyl)-aniline sodium salt (“DAOS”), Triton X-100; and sodium cholate. The mixture is sprayed on the end of the arms 21 and 22. The center of arm 21 is air-brushed with a standard precipitating agent for LDL-cholesterol and VLDL-cholesterol, i.e., Polyethyleneglycol, (PEG-6000). This removes LDL and VLDL cholesterol from the sample by precipitation and permits the plasma containing only HDL-cholesterol to reach the end of the arm 21 where the reagents for cholesterol measurement are deposited. In this FIG. 9, the end of the arm 24 is the location of the standard combination reagent for triglyceride measurement consisting of lipoprotein Lipase, adenosine-5-triphosphate disodium salt (ATP), glycerol kinase, glycerol-3-phosphate oxidase, horseradish peroxidase, 4-aminoantipyrine, DAOS, and Triton x-100 in phosphate buffer at pH 7.0. In this example, all three chemistries produce hydrogen peroxide, the concentration of which is proportional to and is measured by 4-aminoantipyrine, DAOS, and peroxidase. The intensity of this color is measured quantitatively by an appropriate reflectance meter at a wavelength between 600-660 nm. DAOS dye can be replaced by other aniline dyes that will produce color at wavelength between 380 and 800 nm when reacted with 4-aminoantipyrine. Alternatively, the production of hydrogen peroxide or the disappearance of oxygen during the reaction can be measured by electrochemical or potentiometric methods that are well known in prior art. For screening tests, visual color detection may be sufficient to distinguish abnormal samples from normal samples.

Similarly, a device equipped for measurement of tests for a kidney panel has at least four arms each prepared to conduct one of the four tests, i.e. blood urea nitrogen (BUN), creatinine, ammonia, and albumin. Instead of or in addition to albumin, the panel may also conduct tests for total protein and phosphorous. The chemical reactions for measurements of these analytes are well known in the prior art. For example, BUN and creatinine can each be measured enzymatically using urease for BUN and creatinine iminohydrolase for creatinine. Both produce ammonia, which reacts with bromophenol blue to produce color. For these measurements, the bromophenol blue is deposited in a separate pad located above or below the main reagent layer and separated therefrom by a semipermeable membrane. Endogenous ammonia is also measured in a separate arm, and the value obtained for ammonia is subtracted from the BUN and creatinine values to obtain accurate results for each. Albumin is measured by reacting albumin with bromocresol green at a pH of about 3.1. This produces a blue color and is measured at a 600-660 nm wavelength. Total Protein may be measured using a reagent containing copper tartrate in the presence of a strongly alkaline solution of lithium hydroxide.

FIG. 11 shows another variation of panel tests where BUN is measured chemically using ophthaldehyde which reacts with urea and produces 1,3 dihydroxyisoindoline which in turn reacts with N-1-naphthyl-diethylenediamine-oxalic acid under acidic conditions to produce a blue color. In this case, ophthaldehyde and N-1 napthyl-diethylenediamine-oxalic acid need to be separated due to significantly different pH requirements for their reactions. Therefore, as shown in FIG. 11, in the arm with BUN reagents ophthaldehyde is air-brushed at a separate pH regulated situs on the arm from N-1 naphthyl-diethylenediamine-oxalic acid, which appears at the end of the arm. When the sample flows from the center, it picks up ophthaldehyde and carries the resultant product 1,3 dihydroxyisoindoline to the end of the arm, where it reacts with the dye to produce color proportional to the BUN content of the sample.

As is clear from the foregoing, in any situation where two necessary reagents for a test are for any reason incompatible, including a tendency to prereact with one another, these reagents can readily be placed at two different sites on the same arm. This provides the arm equipped to run the test with an optimal shelf life. Similarly, in FIG. 11, the arm 22 of the device, for the creatinine test, is prepared to run an enzymatic test involving a cascade of enzymes, namely, creatinine iminohydrolase, N-methylhydantoinase along with adenosine-5-phosphate, N-methylcarbamylsarcosinehydrolase, and sarcosine oxidase. The test produces hydrogen peroxide in proportion to the concentration of creatinine in the sample. Hydrogen peroxide is measured using the dye-3,3′,5,5′,tetramethylbenzidine (TMB) instead of 4-aminoantipyrine and an aniline derivative. TMB is a very sensitive dye and has a high molecular coefficient that allows measurement of creatinine at a very low range with good discrimination at concentrations as low as 1-2 mg/dl.

For a kidney panel, as already noted, the combination of the tests can be varied and may include total protein or phosphorus in a place of or in addition to ammonia or albumin. The reagents for albumin and protein were previously mentioned. A phosphorus reagent combination contains ammonium molybdate and p-methylaminophenol at a low pH.

The device equipped for a panel of liver tests has a similar configuration to that shown in FIG. 1. The device contains reagents at the end of one of the four arms for measurement of each of alanine aminotransferase (ALT), aspartate aminotransferase (AST), alkaline phosphatase and bilirubin, respectively. The combination of tests can vary and may include lactate dehydrogenase or gamma-glutaryl transferase. The reagents for ALT generally comprise L-alanine, alpha ketoglutarate, potassium phosphate, pyruvate oxidase, magnesium chloride and peroxidase, with a hydrogen peroxide detecting system such as 4-aminoantipyrine and a phenol derivative, such as DAOS or 3-(-ethyl-3 methylanilino)-2-hydroxypropane sulfonic acid (“TOOS”). The reagents for AST are similar to those for ALT, except L-alanine sulfonic acid is substituted for L-alanine. The reagent for alkaline phosphatase is comprised of indoxyl phosphate at alkaline pH. The reagent for bilirubin contains diazotized sulfanilic acid and 1, 3 dimethylxanthine (“diphylline”). As liver panel tests measure enzymes found in liver and their activity is directly related to the assay temperature, the instrument must be equipped with a temperature probe and a correction in assay values based upon assay temperature is made according to known procedures.

Similar to FIG. 9, the test panel for heart malfunction (Cardiac disorders) may consist of measurement of activity of creatinine kinase (CK), creatinine kinase (MB), lactate dehydrogenase (LDH), and albumin. The reagents for such tests are well known. The reagent for measurement of creatinine kinase activity is comprised of creatinine phosphate, adenosinediphosphate, glucose, hexokinase, NADP, glucose-6-phosphate dehydrogenase, diaphorase and tetrazolium salts such as NBT (nitroblue tetrazolium). CK-MB reagents are the same as for CK, except that the center of the arm contains antibodies to CK-MM that capture the CK-MM isozyme and allow only CK-MB to flow to the reagent site, i.e. the end of the arm. The reagent for LDH contains lactate, nicotinamide adenine dinucleotide (NAD), diaphorase, and nitroblue tetrazolium (NBT).

A test panel for electrolyte monitoring can contain various combinations of tests, such as sodium, potassium, chloride and carbonate. The enzymatic method for measurement of sodium and potassium is known and involves activation of enzymes specific to sodium or potassium. Alternatively, potassium is also measured by an ion-selective reaction using a potassium-selective ionophore. The release of proton is measured as a change in absorption of the dye, for example, 7-(N-decyl)-2-methyl-4-(5′-dichlorphen-4′on)-indonapthol,2,3naptho-15-crown-5, (here “crown” denotes a metal complex). Chloride can also be determined by measuring chloride inhibition to specific enzymes such as salicylate hydroxylase. The reagent contains salicylate hydroxylase, catechol oxidase and 3-methyl-2-benzothiazolinone hydrazone hydrocholoride (“MBTH”). Similarly, the reagent for carbon dioxide is comprised of phosphoenopyruvate, polycthylenepropyl carboxylase and a thio or acetate derivative of NADH.

Reagent combinations for measuring glucose, uric aid, alpha-amylase, calcium, magnesium, and lipase in addition to tests and methodologies may also be included in test panels as desired. Glucose may be measured by glucose oxidase, peroxidase, and a hydrogen peroxide detecting colorimetric or electrochemical system. Uric acid may be measured similarly to glucose, except that uricase is substituted for glucose oxidase. Calcium may be measured by Arsenazo III (i.e., 2,2′-(8-dihydroxy-3,6-disulfo-2,7-naphthalene-bis (azo) diabenzene arsonic acid) at pH 5.6 or by o-cresophthaleine complexone. Magnesium is measured by a formazane dye, preferably 1,5 bis(2-hydroxy-3,5dichlorophenyl)-3-cyanoformazane. Lipase is measured by a lipid substrate and a glycerol phosphate oxidase, peroxidase, 4 aminoantipyrine and DAOS or another aniline derivative.

For chemistry tests to detect metabolic disease in neonatal patients, phenylalanine may be measured with a reagent comprised of phenylalanine dehydrogenase, NAD, NBT and diaphorase; galactose may be measured by substituting galactose dehydrogenase for phenylalanine dehydrogenase in the same reagent mixture.

All of the examples of the device configuration which are shown herein can be used for diagnosis of diseases or in generally checking health of human and other mammalian patients. Mammals may include large animals, such as horses and small ones, such as household pet cats and dogs.

The devices described herein can be miniaturized to effectively use less sample and reagent volumes.

The device of this invention is useful for simultaneous measurement of several analytes from a biological sample other than whole blood, such as urine or saliva. Currently, urine test strips with multiple test pads are being used by physicians for preliminary screening. The device of this invention constitutes an alternative format that has the distinct advantage of requiring placement of sample only at one place and needs only a very small amount of sample in comparison to currently used urine strips. Common analytes tested in urine are glucose, bilirubin, pH, urobilinogen, urea, hemoglobin, specific gravity, ketone bodies, leukocytes, nitrite, total protein, albumin, microalbumin, creatinine, oxalate, and N-acetyglucosaminidase; any combination of multiple tests may be employed. The reagents and chemistries for these analytes are well known in prior art.

The said device can also be adapted for multiple testing in saliva for alcohol, barbiturates etc.

In other industries, the need for simultaneous measurement of various analytes in foods, drugs, soils, fermentation processes and environmental contaminants can be fulfilled by the device of this invention. Exemplary of commonly performed tests are those for carbohydrates, lipids, cholesterol, protein and nitrogen levels in foods. Another example is the measurement of levels of ammonia, glucose, inducer (substrate) and pH in fermentation processes.

In the area of testing of environmental water whether for drinking, swimming, or for fish habitats, the device described herein could be very helpful because it allows simultaneous measurement of various analytes with a small sample. For example, in testing of water for swimming pools, the device of this invention can readily be prepared to determine total chlorine, free chlorine, total hardness, pH, total alkalinity and ammonia, or any combination of these, on a single sample. The reagent chemistry for such tests is well known in the prior art.

The foregoing description of specific embodiments so fully reveals the general nature of this invention that others can, by applying current knowledge, readily modify and/or adapt it for various applications without undue experimentation and without departing from the overall concept as herein described. Accordingly, such adaptions and modifications are intended to be included within the meaning and range of equivalents of the disclosed embodiments. It is to be understood that the phraseology or terminology employed herein is for the purpose of exemplification and description and is not intended to limit the concept in any way. The means, materials, and steps for carrying our various disclosed functions may take a variety of alternative forms without departing from the invention.

1. A device for detecting and measuring the concentrations of multiple analytes present in a single liquid sample, which device comprises a matrix material supported on a rigid to semirigid support material, wherein said matrix material comprises
a) a central sample receiving portion, which portion is connected to
b) at least two outwardly extending arms along which liquid sample flows outwardly from the central sample receiving portion, wherein
c) each separate arm has been prepared by impregnation with reagents needed to conduct a test for the detection and measurement of a predetermined analyte believed to be present in said liquid sample, which reagents react with said analyte to produce a measurable signal that is proportional to the concentration of said analyte in said sample:

2. The device according to claim 1 wherein sample applied is selected from the group consisting of whole blood, plasma or serum.

3. The device according to claim 1 wherein sample applied is urine.

4. The device according to claim 1 wherein sample applied is saliva.

5. The device according to claim 1 wherein the sample applied is an extract selected from the group consisting of food, drug, soil, or plant.

6. The device according to claim 1 wherein the sample applied is environmental water.

7. The device according to claim 6 where the sample is selected from among tap water, swimming pool water, or fish tank water.

8. The device according to claim 1 wherein the matrix is a membrane, or a filter paper.

9. The device according to claim 1 wherein the matrix is prepared from one or a combination of two or more membranes selected from among asymmetric membranes and polyethylene sulfone membranes.

10. The device according to claim 9 where in the matrix may be prepared from a combination of membranes and filter paper, with bridge pads included where junctions of membranes and paper occur.

11. The device according to claim 1 wherein the number of connected arms may vary from 2 to 16.

12. The device according to claim 1 wherein the measurable signal produced is calorimetric, fluorescent or electrochemical.

13. The device according to claim 12 wherein the signal produced at each reagent site is a color that is measured by a device comprised of at least one light emitting diode and at least one light detector in the range between 360 and 880 nm wavelength.

14. The device according to claim 2 wherein the central sample receiving location is connected to separate arms, each equipped to measure one analyte, and there are reagents present for measuring at least two analytes selected from among total cholesterol, HDL-cholesterol, triglyceride, LDL-cholesterol, glucose and alanine aminotransferase.

15. The device according to claim 2 wherein the central sample receiving location is connected to separate arms, each equipped to measure one analyte, and there are reagents present for measuring at least two analytes selected from among blood urea nitrogen, creatinine, albumin, total protein, phosphate, and ammonia.

16. The device according to claim 2 wherein the central sample receiving location is connected to separate arms, each equipped to measure one analyte, and there are reagents present for measuring at least two analytes elected from among alanine aminotransferase, bilirubin, alkaline phosphatase, aspartate aminotransferase and lactate dehydrogenase.

17. The device according to claim 2 wherein the central sample receiving location is connected to separate arms, each equipped to measure one analyte, and there are reagents present for measuring at least two analytes selected from among creatinine kinase, creatinine kinase-MB, lactate dehydrogenase, albumin and homocysteine.

18. The device according to claim 2 wherein the central sample receiving location is connected to separate arms, each equipped to measure one analyte, and there are reagents present for measuring at least two analytes selected from among sodium, potassium, chloride, and carbon dioxide.

19. The device according to claim 2 wherein the central sample receiving location is connected to separate arms, each equipped to measure one analyte, and there are reagents present for measuring more than two analytes, said analytes being selected from among glucose, cholesterol, triglyceride, alanine aminotransferase, aspartate aminotransferase, alkaline phosphatase, lactate dehydrogenase, creatinine kinase, creatinine kinase MB, bilirubin, calcium, magnesium, phosphorus, total protein, albumin, urea, creatinine, uric acid, HDL-cholesterol, lipase, ammonia, gammaglutaryl transferase, sodium, potassium, chloride, and carbon dioxide to form a General Health Panel.

20. The device according to claim 2 wherein the central sample receiving location is connected to separate arms, each equipped to measure one analyte, and there are reagents present for measuring at least two analytes selected from among phenylalanine, galactose, and homocysteine.

21. The device according to claim 2 wherein the central sample receiving location is connected to separate arms, each equipped to measure one analyte, and there are reagents present for measuring at least two analytes selected from among hemoglobin, glycated hemoglobin, ketone bodies and glucose.

22. The device according to claim 2 wherein the central sample receiving location is connected to separate arms, each equipped to measure one analyte, and there are reagents present for measuring at least two analytes selected from among glucose-6-phosphate dehydrogenase, pyruvate kinase, and glucose phosphate isomerase.

23. The device according to claim 3 wherein the central sample receiving location is connected to separate arms, each equipped to measure one analyte, and there are reagents present for measuring at least two analytes selected from among glucose, bilirubin, pH, urobilinogen, urea, hemoglobin, specific gravity, ketone bodies, leukocytes, nitrite, total protein, albumin, microalbumin, creatinine, oxalate, and N-acetyglucosaminidase.

24. The device according to claim 4 wherein the central sample receiving location is connected to separate arms, each equipped to measure one analyte, and there are reagents present for at least two of the analytes measuring alcohol and one or more barbiturates.

25. The device according to claim 5 wherein the central sample-receiving location is connected to separate arms, each equipped to measure one analyte, and there are reagents present for measuring at least two analytes selected from among glucose, cholesterol, ammonia, protein, nitrogen and lipids.

26. The device according to claim 6 wherein the central sample receiving location is connected to separate arms, each equipped to measure one analyte, and there are reagents present for measuring at least two analytes selected from among total chlorine, free chlorine, total hardness, pH, total alkalinity ammonia and combinations thereof.

27. A device according to claim 1 wherein the separate arms of the device are equipped to measure, simultaneously on one patient fluid sample, a group of analytes selected to aid in identifying a kidney disorder.

28. A device according to claim 1 wherein the separate arms of the device are equipped to measure, simultaneously on one patient fluid sample, a group of analytes selected to aid in identifying a cardiac disorder.

29. A device according to claim 1 wherein the separate arms of the device are equipped to measure, simultaneously on one patient fluid sample, a group of analytes selected to aid in identifying a liver disorder.

30. A device according to claim 1 wherein the separate arms of the device are equipped to measure, simultaneously on one patient fluid sample, a group of analytes selected to aid in identifying a lipid-caused disorder.

31. A device according to claim 1 wherein the separate arms of the device are equipped to measure, simultaneously on one patient fluid sample, a group of analytes selected to aid in monitoring electrolyte balance or diagnosing electrolyte imbalance.

32. A device according to claim 1 wherein the separate arms of the device are equipped to measure, simultaneously on one patient fluid sample, a group of analytes selected to aid in monitoring general health or detecting unexpected dysfunction.

33. A device according to claim 1 wherein the separate arms of the device are equipped to measure, simultaneously on one patient fluid sample, a group of analytes selected to aid in identifying diabetes.

34. A device according to claim 1 wherein the separate arms of the device are equipped to measure, simultaneously on one patient fluid sample, a group of analytes selected to aid in identifying neonatal genetic disorder.

35. A device according to claim 1 wherein the separate arms of the device are equipped to measure, simultaneously on one patient fluid sample, a group of analytes selected to aid in identifying enzyme defects in erythrocytes.

36. The device of claim 1 wherein the sample introduced to the sample receiving location is capillary blood.

37. The device of claim 36 wherein capillary blood is obtained from the patient's finger, heel or earlobe.

38. A device according to claim 1 wherein the separate arms of the device are equipped to measure, simultaneously on one patient fluid sample, a group of analytes selected to aid in identifying key metabolites and metabolic by-products.
